(19) United States
(12) Patent Application Publication
(10) Pub. No.: US 2025/0093905 A1
(43) Pub. Date: Mar. 20, 2025

(54) Offloaded intra-system synchronization

(71) Applicant: MELLANOX TECHNOLOGIES, LTD., Yokneam (IL)

(72) Inventors: Wojciech Wasko, Mlynek (PL); Dotan David Levi, Kiryat Motzkin (IL); Natan Manevich, Nesher (IL); Maciej Machnikowski, Reda (PL)

(21) Appl. No.: 18/470,452

(22) Filed: Sep. 20, 2023

(51) Int. Cl. G06F 1/12; G06F 13/42; H04L 7/033

(52) U.S. Cl. CPC G06F 1/12; G06F 13/4291; H04L 7/033

(57) ABSTRACT

In one embodiment, a peripheral device includes an oscillator, a counter to be driven by the oscillator and provide a peripheral device counter value, and processing circuitry to receive a host device counter value from a host device, read host device clock translation parameters from a host memory of the host device, the host device clock translation parameters providing translation between the host device counter value and a host device clock time, read peripheral device clock translation parameters providing a translation between the peripheral device counter value and a peripheral device clock time, read the peripheral device counter value, compute a clock correction as a function of a difference between the host device clock time and the peripheral clock time, based on the host device and peripheral device counter values and clock translation parameters, and correct the host device or peripheral device clock translation parameters based on the clock correction.

### FIELD OF THE INVENTION

The present invention relates to computer systems, and in particular, but not exclusively, to clock synchronization.

### BACKGROUND

A hardware clock in a network device may be disciplined to a remote clock such as a clock over the network or to a Global navigation satellite system (GNSS). Many clock synchronization methods are available to provide accurate clock synchronization. One such method is based on the Precision Time Protocol (PTP), for example.

A hardware clock in a host device connected to the network device may synchronize to the hardware clock in the network device. One method is for the host device to poll the network device several times for the time maintained by the network device and take an average of the received times. This method may introduce errors of at least a few hundred nanoseconds, which in many applications is too large.

Another method for synchronizing the clock of a host device to the clock of a network device is Precision Time Measurement (PTM), a supported feature in the PCI-SIG® PCI Express 3.0 specification, which defines a new protocol of timing measurement and synchronization messages for time-sensitive media and server applications. Examples include industrial automation, instrumentation, geological sciences, telecom synchronization, and synchronized audio/video systems, among others. PTM enables systems that require high precision timing, the ability to monitor and track the time of transactions with sub-microsecond timing accuracy while accelerating server application performance.

### SUMMARY

There is provided in accordance with an embodiment of the present disclosure, a peripheral device, including an oscillator, a counter to be driven by the oscillator and provide a peripheral device counter value, and processing circuitry to receive a host device counter value from a host device, read host device clock translation parameters from a host memory of the host device, the host device clock translation parameters providing a translation between the host device counter value and a host device clock time, read peripheral device clock translation parameters, the peripheral device clock translation parameters providing a translation between the peripheral device counter value and a peripheral device clock time, read the peripheral device counter value, compute a clock correction as a function of a difference between the host device clock time and the peripheral clock time, based on the host device counter value, the host device clock translation parameters, the peripheral device counter value, and the peripheral device clock translation parameters, and correct the host device clock translation parameters or the peripheral device clock translation parameters based on the clock correction.

Further in accordance with an embodiment of the present disclosure the peripheral device clock translation parameters are stored in the host memory, and the processing circuitry is configured to read the peripheral device clock translation parameters from the host memory.

Still further in accordance with an embodiment of the present disclosure the processing circuitry is to correct the peripheral device clock translation parameters thereby causing the peripheral device clock time to follow the host device clock time.

Additionally in accordance with an embodiment of the present disclosure the peripheral device clock translation parameters are stored in the host memory, and the processing circuitry is to correct the peripheral device clock translation parameters in the host memory.

Moreover, in accordance with an embodiment of the present disclosure the peripheral device clock translation parameters are stored in the peripheral device, and the processing circuitry is to correct the peripheral device clock translation parameters stored in the peripheral device.

Further in accordance with an embodiment of the present disclosure the processing circuitry is to correct the host device clock translation parameters thereby causing the host device clock time to follow the peripheral device clock time.

Still further, in accordance with an embodiment of the present disclosure the processing circuitry is to receive the host device counter value from a data communication bus root port of the host device.

Additionally in accordance with an embodiment of the present disclosure the processing circuitry is to correct multiple sets of peripheral device translation parameters providing translations between the peripheral device counter value and respective peripheral device clock times with respect to respective host device clock times of respective multiple host machines.

Moreover, in accordance with an embodiment of the present disclosure the processing circuitry is to correct the multiple sets of the peripheral device translation parameters stored in host memories of the respective multiple host machines.

Further in accordance with an embodiment of the present disclosure the processing circuitry is to correct multiple sets of host device translation parameters providing translations between host device counter values and respective host device clock times of respective multiple host machines with respect to the peripheral device clock time causing each of the host device clock times to follow the peripheral device clock time.

Still further, in accordance with an embodiment of the present disclosure the processing circuitry is to correct the multiple sets of the host device translation parameters stored in host memories of the respective multiple host machines.

There is also provided in accordance with still another embodiment of the present disclosure a system, including the peripheral device, and a host device to execute software to offload to the peripheral device computation of the clock correction, and correction of the host device clock translation parameters or the peripheral device clock translation parameters based on the clock correction.

There is also provided in accordance with another embodiment of the present disclosure, a host device, including an oscillator, a counter to be driven by the oscillator and provide a host device counter value, a host memory to store host device clock translation parameters providing a translation between the host device counter value and a host device clock time, a data communication bus root port to receive a peripheral device counter value from a peripheral device via a data communication bus, read peripheral device clock translation parameters from the host memory, the peripheral device clock translation parameters providing a translation between the peripheral device counter value and a peripheral device clock time, read the host device clock translation parameters from the host memory, compute a clock correction as a function of a difference between the host device clock time and the peripheral clock time, based on the host device counter value, the host device clock translation parameters, the peripheral device counter value, and the peripheral device clock translation parameters, and correct the host device clock translation parameters or the peripheral device clock translation parameters based on the clock correction.

Additionally in accordance with an embodiment of the present disclosure the data communication bus root port is to correct the peripheral device clock translation parameters thereby causing the peripheral device clock time to follow the host device clock time.

Moreover, in accordance with an embodiment of the present disclosure the data communication bus root port is to correct the host device clock translation parameters thereby causing the host device clock time to follow the peripheral device clock time.

There is also provided in accordance with still another embodiment of the present disclosure a method, including driving a counter by an oscillator, providing, by the counter, a peripheral device counter value, receiving a host device counter value from a host device, reading host device clock translation parameters from a host memory of the host device, the host device clock translation parameters providing a translation between the host device counter value and a host device clock time, reading peripheral device clock translation parameters, the peripheral device clock translation parameters providing a translation between the peripheral device counter value and a peripheral device clock time, reading the peripheral device counter value, computing a clock correction as a function of a difference between the host device clock time and the peripheral clock time, based on the host device counter value, the host device clock translation parameters, the peripheral device counter value, and the peripheral device clock translation parameters, and correcting the host device clock translation parameters or the peripheral device clock translation parameters based on the clock correction.

Further in accordance with an embodiment of the present disclosure the correcting includes correcting the peripheral device clock translation parameters thereby causing the peripheral device clock time to follow the host device clock time.

Still further in accordance with an embodiment of the present disclosure the correcting includes correcting the host device clock translation parameters thereby causing the host device clock time to follow the peripheral device clock time.

Additionally in accordance with an embodiment of the present disclosure the correcting includes correcting multiple sets of peripheral device translation parameters providing translations between the peripheral device counter value and respective peripheral device clock times with respect to respective host device clock times of respective multiple host machines.

Moreover, in accordance with an embodiment of the present disclosure the correcting includes correcting multiple sets of host device translation parameters providing translations between host device counter values and respective host device clock times of respective multiple host machines with respect to the peripheral device clock time causing each of the host device clock times to follow the peripheral device clock time.

There is also provided in accordance with still another embodiment of the present disclosure a method, including driving a counter by an oscillator, providing, by the counter, a host device counter value, storing host device clock translation parameters providing a translation between the host device counter value and a host device clock time, receiving, by a data communication bus root port, a peripheral device counter value from a peripheral device via a data communication bus, reading, by the data communication bus root port, peripheral device clock translation parameters from the host memory, the peripheral device clock translation parameters providing a translation between the peripheral device counter value and a peripheral device clock time, reading, by the data communication bus root port, the host device clock translation parameters from the host memory, computing, by the data communication bus root port, a clock correction as a function of a difference between the host device clock time and the peripheral clock time, based on the host device counter value, the host device clock translation parameters, the peripheral device counter value, and the peripheral device clock translation parameters, and correcting, by the data communication bus root port, the host device clock translation parameters or the peripheral device clock translation parameters based on the clock correction.

### BRIEF DESCRIPTION OF THE DRAWINGS

The present invention will be understood from the following detailed description, taken in conjunction with the drawings in which:

FIG. 1 is a block diagram view of a clock synchronization system constructed and operative in accordance with an embodiment of the present invention;

FIG. 2 is a flowchart including steps in a method of operation of the system of FIG. 1;

FIGS. 3 and 4 are block diagram views of the system of FIG. 1 illustrating steps in the method of FIG. 2;

FIGS. 5 and 6 are block diagram views of multi-host clock synchronization systems constructed and operative in accordance with an embodiment of the present invention;

FIG. 7 is a flowchart including steps in an alternative method of operation of the system of FIG. 1; and

FIGS. 8 and 9 are block diagram views of the system of FIG. 1 illustrating steps in the method of FIG. 7.

### DESCRIPTION OF EXAMPLE EMBODIMENTS

### Overview

A device may track time using a counter which counts oscillations of an oscillator or another frequency source. The value of the counter generally does not correspond to a wall-clock time (e.g., a time-of-day value). Although it is possible to have a wall-clock clock in hardware, the general procedure is to maintain translation parameters which software uses to translate from the value of the counter to a wall-clock time (e.g., using a Kernel mode driver). The Kernel space may expose a memory location holding the translation parameters to user space so that the translation parameters are exposed to user space software to allow computation of the wall-clock time by user space software. The user space software reads the counter value and computes the wall-clock time using the translation parameters without having to ask the Kernel space to compute the wall-clock time. The above may be performed by central processing units (CPUs) and/or graphics processing units (GPUs).

In some scenarios, a host device may discipline its clock based on the clock of a peripheral device (such as a network interface controller (NIC)) connected to the host device using software running on the CPU of the host device, for example using PTM. This clock synchronization method may use a disproportionate amount of CPU resources and may be subject to crashing or being terminated to save memory, for example. In cloud computing scenarios, the CPU may be a particularly scarce and expensive resource making use of the CPU for clock synchronization more problematic.

One solution is to offload part of the synchronization from the CPU to a Peripheral Component Interconnect Express (PCIe) root port on host side, which performs many of the clock synchronization interactions with the peripheral device. This provides a more robust solution to clock synchronization. However, when the peripheral device requests the host side time, it receives a counter value which the kernel mode driver running on the hosts translates to a wall-clock value and therefore the host CPU is still involved throughout the clock synchronization process.

Embodiments of the present invention address at least some of the above drawbacks by offloading clock synchronization from a CPU of a host device to a peripheral device connected the host device and/or to a data communication bus root port.

In some embodiments, the peripheral device receives a host device counter value from the host device, for example, via a PTM interaction, with hardware of the host device, such as, the data communication bus root port. The peripheral device reads host device clock translation parameters from host memory. The host device clock translation parameters allow the peripheral device to compute the host device wall-clock time from the received host device counter value. In this manner, the host software does not need to be involved with computing the host device wall-clock time from the host device counter value. The peripheral device also retrieves it local counter value and the peripheral device clock translation parameters, which allow the peripheral device to compute a wall-clock time of the peripheral device from the retrieved peripheral device counter value. The peripheral device may then compute a clock correction based on the difference between the peripheral wall-clock time and the host device host wall-clock time. The peripheral device may then correct the host device clock time by correcting the host device clock translation parameters (so that the host device clock follows the peripheral device clock) or correct the peripheral device clock time by correcting the peripheral device clock translation parameters (so that the peripheral device clock follows the host device clock). In some embodiments, the peripheral device translation parameters are stored in peripheral device memory. In other embodiments, the peripheral device translation parameters are stored in the host memory. In the above manner, the peripheral device performs most of the clock synchronization steps, while host side hardware such as the data communication bus root port provides the host device counter value to the peripheral device. The peripheral device may perform the clock synchronization steps using hardware and/or firmware.

The above offloading process may be initiated by software or firmware running on the host device, but once offloading has been completed the software or firmware does not need to perform steps in the clock synchronization process. The offloading process may include instructing the peripheral device to perform clock synchronization with the data communication bus root port, and may also include providing access to the various counters and parameters by the peripheral device and/or the data communication bus root port.

In the above manner, the peripheral device may perform clock synchronization with multiple host devices or multiple virtual machines. In such a case, there may be multiple instances of the peripheral device translation parameters, so that for each host device there is a set of host device translation parameters and peripheral device translation parameters. It may be particularly useful to store the respective peripheral device translation parameters in the respective host memories.

In some embodiments, the data communication bus root port may perform many of the clock synchronization steps, such as retrieving the host device counter value and the host device clock translation parameters from host memory. The data communication bus root port may also receive the peripheral device counter value, for example, via a PTM interaction with the peripheral device, and retrieve the peripheral device clock translation parameters from host memory. The data communication bus root port may then compute a clock correction based on the difference between the peripheral wall-clock time and the host device host wall-clock time. The data communication bus root port may then correct the host device clock time by correcting the host device clock translation parameters (so that the host device clock follows the peripheral device clock) or correct the peripheral device clock time by correcting the peripheral device clock translation parameters (so that the peripheral device clock follows the host device clock). In the above manner, the data communication bus root port performs most of the clock synchronization steps, while the peripheral device provides the peripheral device counter value to the data communication bus root port.

### System Description

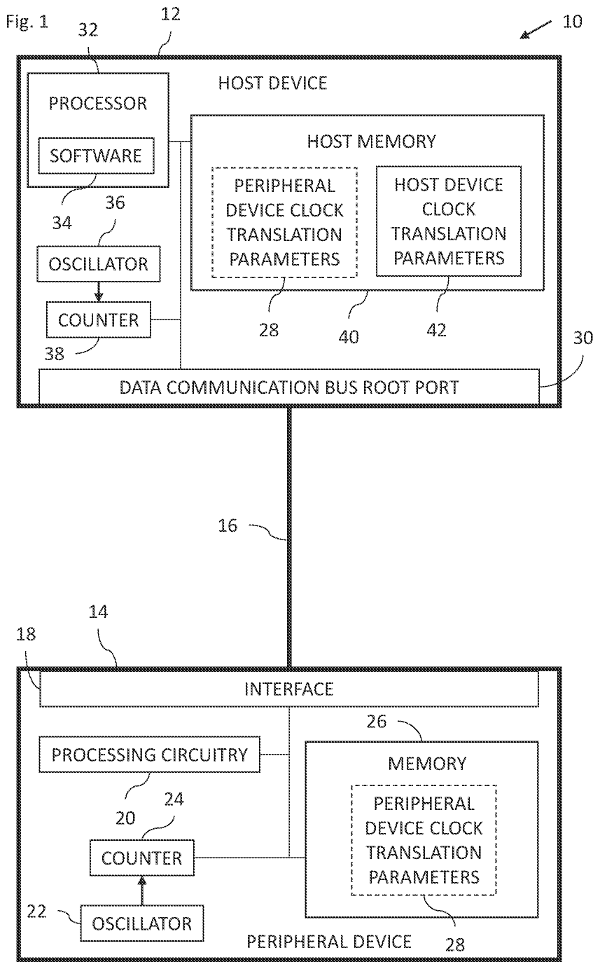

Reference is now made to FIG. 1, which is a block diagram view of clock synchronization system 10 constructed and operative in accordance with an embodiment of the present invention. The clock synchronization system 10 includes a host device 12 and a peripheral device 14 connected via a data communication bus 16 operating according to any suitable protocol, for example. PCIe.

The peripheral device 14 includes: an interface 18 configured to be connected to data communication bus 16; processing circuitry 20; an oscillator 22 configured to generate an oscillatory signal; and a counter 24 configured to be driven by the oscillatory signal generated by the oscillator 22. The counter 24 is configured to count features of the oscillatory signal and provide a peripheral device counter value. The peripheral device 14 also includes a memory 26, which may be configured to store peripheral device clock translation parameters 28 providing a translation between the peripheral device counter value and a peripheral device clock time (e.g., wall-clock time or time-of-day value of the peripheral device 14). In some embodiments, the peripheral device clock translation parameters 28 are stored in the host device 12, as described in more detail below.

The host device 12 includes: a data communication bus port 30 configured to be connected to data communication bus 16; a processor 32 configured to execute software 34 described in more detail below; an oscillator 36 configured to generate an oscillatory signal; and a counter 38 configured to be driven by the oscillatory signal generated by the oscillator 36. The counter 38 is configured to count features of the oscillatory signal and provide a host device counter value. The host device 12 also includes a host memory 40, which may be configured to store host device clock translation parameters 42 providing a translation between the host device counter value and a host device clock time (e.g., wall-clock time or time-of-day value of the host device 12). In some embodiments, the host memory 40 is also configured to store the peripheral device clock translation parameters 28.

The data communication bus port 30 may be a PCIe root port. The data communication bus port 30 may be configured as a hardware component running suitable firmware. In some embodiments, the data communication bus port 30 is integrated into a CPU chip including the processor 32. In other embodiments, the data communication bus port 30 is included in a chip which is separate from the CPU chip. The data communication bus port 30 may serve as interface between the processor 32 and all peripheral devices connected to the host device 12. The data communication bus port 30 may be the root of the PCIe hierarchy, control the PCIe hierarchy, and control and enumerate all the peripheral devices.

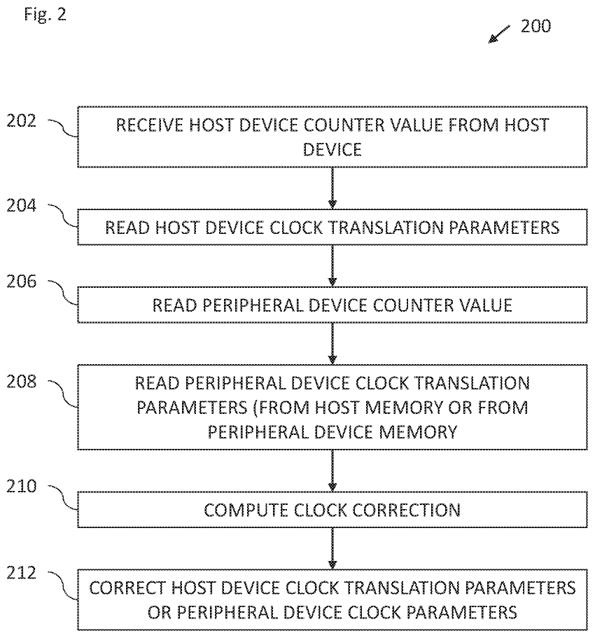

The processor 32 may be configured to execute software 34 to offload one or more of the following to the peripheral device 14: computation of a clock correction (to correct the peripheral device clock translation parameters 28 or the host device clock translation parameters 42 as described in more detail with reference to FIG. 2); and correction of the host device clock translation parameters 42 or the peripheral device clock translation parameters 28 based on the clock correction, as described in more detail with reference to FIG. 2.

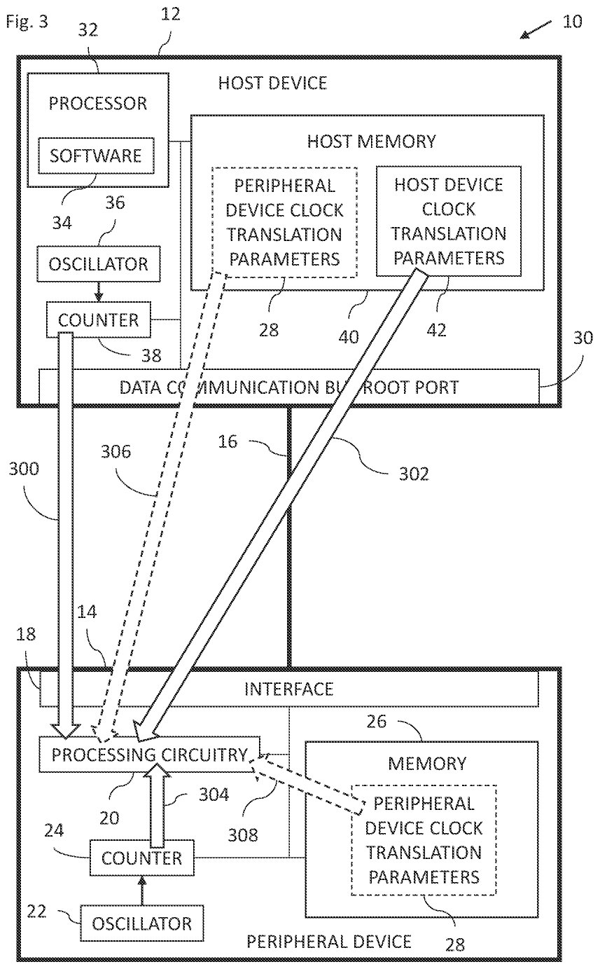

Reference is now made to FIG. 2, which is a flowchart 200 including steps in a method of operation of the system of FIG. 1. Reference is also made to FIG. 3, which is a block diagram view of the system 10 of FIG. 1 illustrating some of the steps in the method of FIG. 2. The processing circuitry 20 is configured to receive a host device counter value from the host device 12 (block 202 and arrow 300). In some embodiments, the processing circuitry 20 is configured to receive the host device counter value from the data communication bus root port 30 of the host device 12 (e.g., via a PTM interaction). The processing circuitry 20 is configured to read host device clock translation parameters 42 from the host memory 40 of the host device 12 (block 204 and arrow 302).

The processing circuitry 20 is configured to read the peripheral device counter value from the counter 24 (block 206 and arrow 304). The processing circuitry 20 is configured to read the peripheral device clock translation parameters 28 (block 208). In embodiments where the peripheral device clock translation parameters 28 are stored in the host memory 40, the processing circuitry 20 is configured to read the peripheral device clock translation parameters 28 from the host memory 40 (arrow 306). In embodiments where the peripheral device clock translation parameters 28 are stored in the memory 26 of the peripheral device 14, the processing circuitry 20 is configured to read the peripheral device clock translation parameters 28 from the memory 26 of the peripheral device 14 (arrow 308).

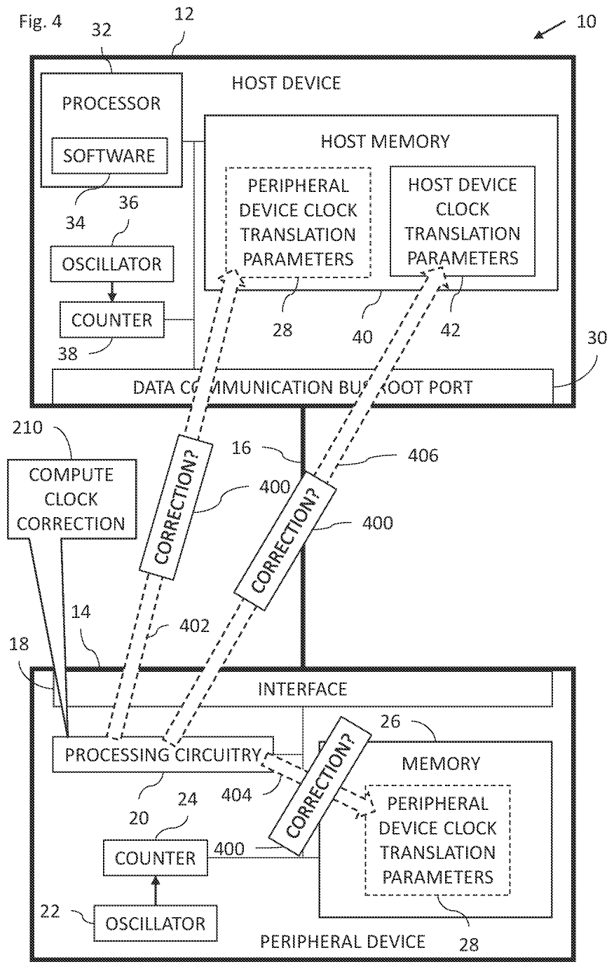

Reference is now made to FIG. 4, which is a block diagram view of the system 10 of FIG. 1 illustrating other steps in the method of FIG. 2. Reference is also made to FIG. 2. The processing circuitry 20 is configured to compute a clock correction 400 as a function of a difference between the host device clock time and the peripheral clock time, based on the received host device counter value, the read host device clock translation parameters 42, the read peripheral device counter value, and the read peripheral device clock translation parameters 28 (block 210). For example, the host device clock time may be computed from the host device counter value and the host device clock translation parameters 42, and the peripheral device clock time may be computed from the peripheral device counter value and the peripheral device clock translation parameters 28.

The processing circuitry 20 is configured to correct the host device clock translation parameters or the peripheral device clock translation parameters based on the clock correction 400 (block 212) as described in more detail below.

In some embodiments, the processing circuitry 20 is configured to correct the peripheral device clock translation parameters 28 based on the clock correction 400 thereby causing the peripheral device clock time to follow the host device clock time. In embodiments where the peripheral device clock translation parameters are stored in the host memory 40, the processing circuitry 20 is configured to correct the peripheral device clock translation parameters 28 in the host memory 40 (arrow 402). In embodiments where the peripheral device clock translation parameters 28 are stored in the memory 26 of the peripheral device 14, the processing circuitry 20 is configured to correct the peripheral device clock translation parameters 28 stored in memory 26 of the peripheral device 14 (arrow 404).

In other embodiments, the processing circuitry 20 is configured to correct the host device clock translation parameters 42 stored in the host memory 40 thereby causing the host device clock time to follow the peripheral device clock time (arrow 406).

In practice, some, or all of the functions of the processing circuitry 20 may be combined in a single physical component or, alternatively, implemented using multiple physical components. These physical components may comprise hard-wired or programmable devices, or a combination of the two. In some embodiments, at least some of the functions of the processing circuitry 20 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

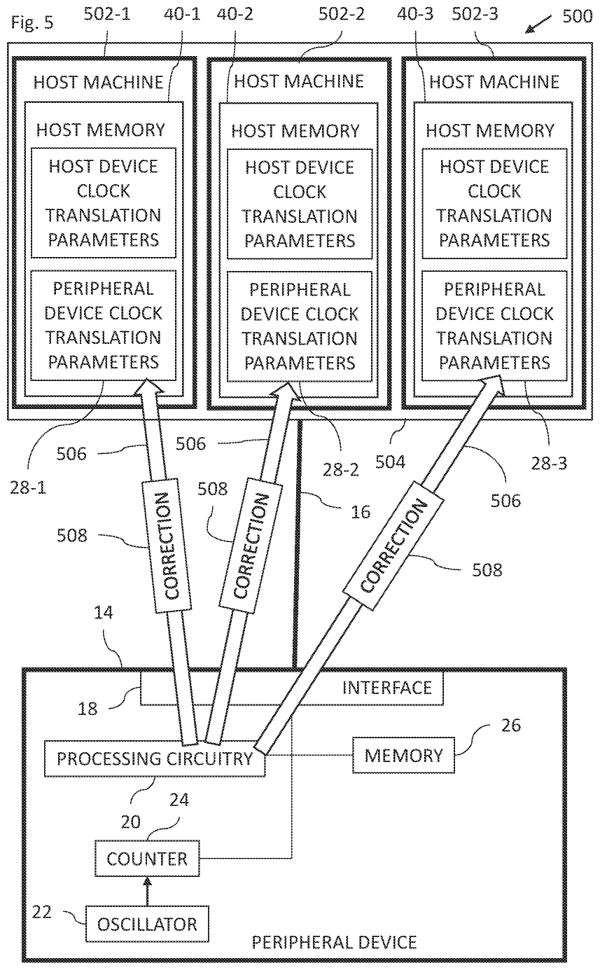

Reference is now made to FIG. 5, which is a block diagram view of a multi-host clock synchronization system 500. The multi-host clock synchronization system 500 includes multiple host machines 502-1, 502-2, 503-3. Each host machine 502 may be substantially the same as the host device 12 or as a virtual machine disposed in a host device 504. The host machines 502 are connected to the peripheral device 14 which serves the host machines 502 and provides clock synchronization services to the host machines 502 in substantially the same manner that the peripheral device 14 performed clock synchronization with host device 12, as described above with reference to FIGS. 1-4. The processing circuitry 20 is configured to compute clock corrections (block 508) with respect to the clock values of the host machines 502, and correct multiple sets of peripheral device translation parameters 28 providing translations between the peripheral device counter value of the counter 24 and respective peripheral device clock times with respect to respective host device clock times of the respective multiple host machines 502 (based on the computed clock corrections) so that the clock of the peripheral device 14 may individually follow the clock of each of the host machines 502 (arrows 506). For example, peripheral device clock translation parameters 28-1 provide a translation between the peripheral device counter value of the counter 24 and the peripheral device clock time so that the computed peripheral device clock time follows the host device clock time of host machine 502-1, peripheral device clock translation parameters 28-2 provide a translation between the peripheral device counter value of the counter 24 and the peripheral device clock time so that the computed peripheral device clock time follows the host device clock time of host machine 502-2, and so on. The processing circuitry 20 is configured to correct the multiple sets of the peripheral device translation parameters 28 stored in host memories 40 of the respective multiple host machines 502. For example, the processing circuitry 20 is configured to correct the peripheral device clock translation parameters 28-1 stored in host memory 40-1, the processing circuitry 20 is configured to correct the peripheral device clock translation parameters 28-2 stored in host memory 40-2, and so on.

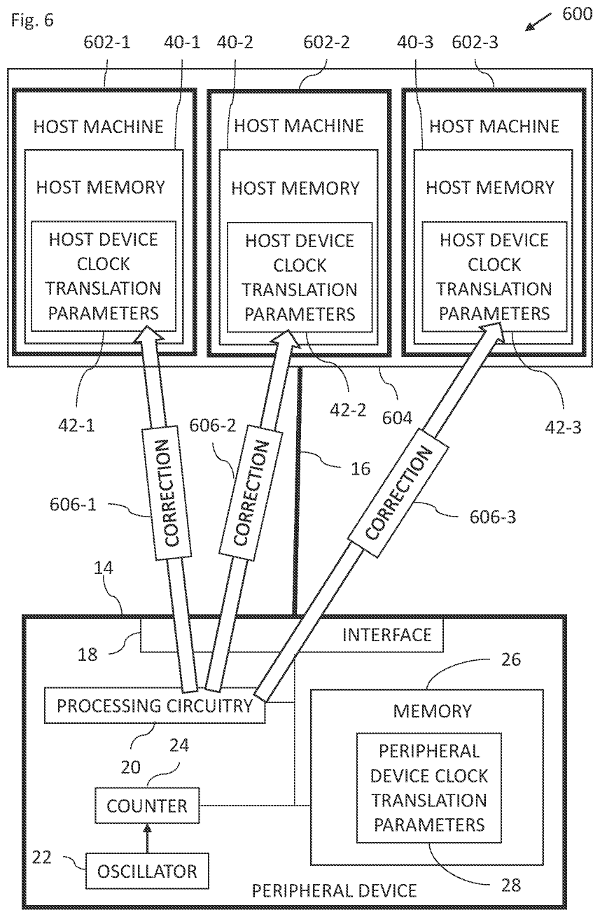

Reference is now made to FIG. 6, which is a block diagram view of a multi-host clock synchronization system 600. The multi-host clock synchronization system 600 may include multiple host machines 602. Each host machine 602 may be substantially the same as the host device 12 or as a virtual machine disposed in a host device 604. The host machines 602 are connected to the peripheral device 14 which serves the host machines 602 and provides clock synchronization services to the host machines 602 in substantially the same manner that the peripheral device 14 performed clock synchronization with host device 12, as described above with reference to FIGS. 1-4. The multi-host clock synchronization system 600 is substantially the same as the multi-host clock synchronization system 500 of FIG. 5 except for the following differences.

In the multi-host clock synchronization system 600, the peripheral device clock translation parameters 28 are stored in the memory 26 of the peripheral device 14, and the host device clock translation parameters 42 of each host machine 602 are individually corrected so that the clock of each host machine 602 follows the clock of the peripheral device 14, as described in more detail below.

The processing circuitry 20 is configured to compute clock corrections (block 606) with respect to the clock value of each of the host machines 602 and the clock time of the peripheral device 14. For example, the processing circuitry 20 is configured to compute a clock correction 606-1 to the clock value of host machine 602-1 with respect to the clock value of peripheral device 14, the processing circuitry 20 is configured to compute a clock correction 606-2 to the clock value of host machine 602-2 with respect to the clock value of peripheral device 14, and so on.

The processing circuitry 20 is configured, based on the computed clock corrections, to correct multiple sets of host device translation parameters 42 providing translations between host device counter values and the respective host device clock times of the respective host machines 602 with respect to the peripheral device clock time causing each of the host device clock times to follow the peripheral device clock time. The processing circuitry 20 is configured to correct the multiple sets of the host device clock translation parameters 42 stored in host memories 40 of the respective multiple host machines 602. For example, the processing circuitry 20 is configured, based on clock correction 606-1, to correct the host device clock translation parameters 42-1 stored in host memory 40-1, the processing circuitry 20 is configured, based on clock correction 606-2, to correct the host device clock translation parameters 42-2 stored in host memory 40-2, and so on. For example, host device clock translation parameters 42-1 provide a translation between the host device counter value of host machine 602-1 and the host device clock time of host machine 602-1 so that the computed host device clock time of host machine 602-1 follows the clock of peripheral device 14, host device clock translation parameters 42-2 provide a translation between the host device counter value of host machine 602-2 and the host device clock time of host machine 602-2 so that the computed host device clock time of host machine 602-2 follows the clock of peripheral device 14,and so on.

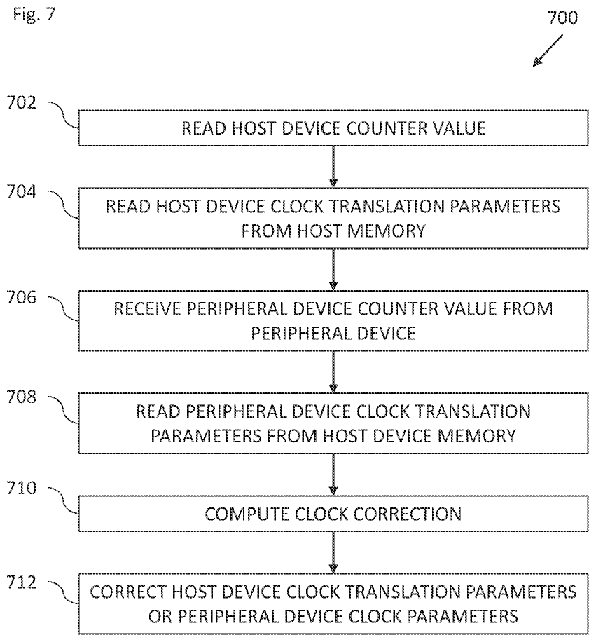

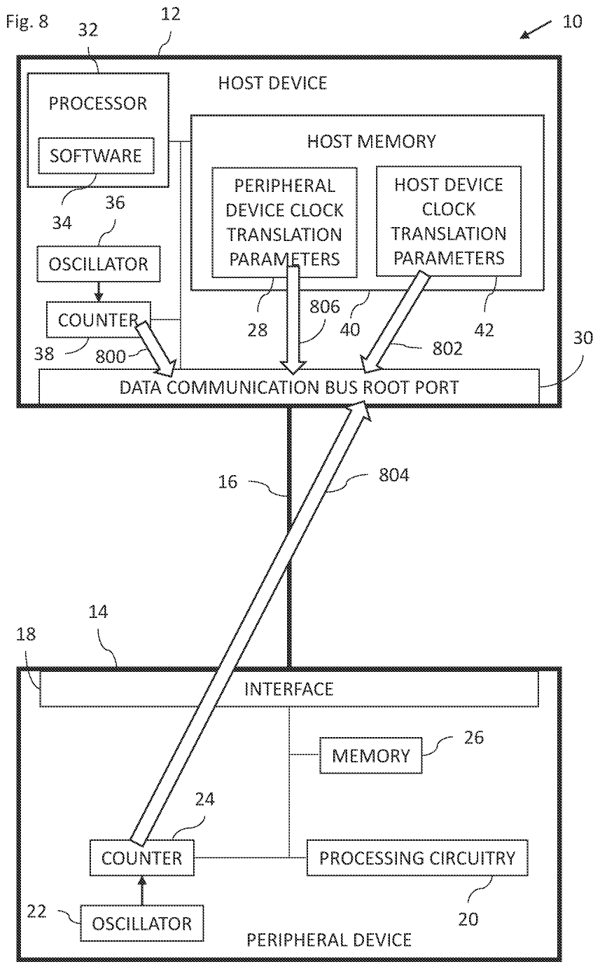

Reference is now made to FIG. 7, which is a flowchart 700 including steps in an alternative method of operation of the system 10 of FIG. 1. Reference is also made to FIG. 8, which is a block diagram view of the system 10 of FIG. 1 illustrating some of the steps in the method of FIG. 7. The data communication bus port 30 is configured to read the host device counter value from the counter 38 (block 702 and arrow 800). The data communication bus port 30 is configured to read the host device clock translation parameters 42 from the host memory 40 (block 704 and arrow 802). The data communication bus port 30 is configured to receive the peripheral device counter value from the peripheral device 14 via the data communication bus 16 (block 706 and arrow 804). The data communication bus port 30 is configured to read peripheral device clock translation parameters 28 from the host memory 40 (block 708 and arrow 806).

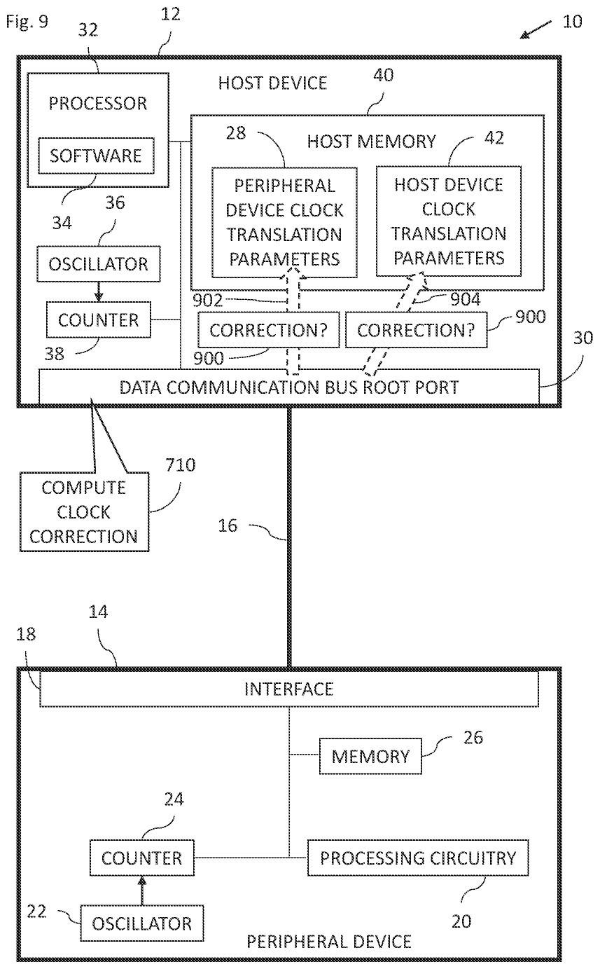

Reference is now made to FIG. 9, which is a block diagram view of the system 10 of FIG. 1 illustrating other steps in the method of FIG. 7. Reference is also made to FIG. 7. The data communication bus port 30 is configured to compute a clock correction 900 as a function of a difference between the host device clock time and the peripheral clock time (block 710), based on the read host device counter value, the read host device clock translation parameters 42, the received peripheral device counter value, and the received peripheral device clock translation parameters 28.

The data communication bus port 30 is configured to correct the host device clock translation parameters 42 or the peripheral device clock translation parameters 28 based on the clock correction 900 (block 712). In some embodiments, the data communication bus root port 30 is configured to correct the peripheral device clock translation parameters 28 (arrow 902) thereby causing the peripheral device clock time to follow the host device clock time. In other embodiments, the data communication bus root port 30 is configured to correct the host device clock translation parameters 42 (arrow 904) thereby causing the host device clock time to follow the peripheral device clock time.

In practice, some, or all of the functions of the data communication bus port 30 may be combined in a single physical component or, alternatively, implemented using multiple physical components. These physical components may comprise hard-wired or programmable devices, or a combination of the two. In some embodiments, at least some of the functions of the data communication bus port 30 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A peripheral device, comprising:
an oscillator;
a counter to be driven by the oscillator and provide a peripheral device counter value; and
processing circuitry to:
receive a host device counter value from a host device;
read host device clock translation parameters from a host memory of the host device, the host device clock translation parameters providing a translation between the host device counter value and a host device clock time;
read peripheral device clock translation parameters, the peripheral device clock translation parameters providing a translation between the peripheral device counter value and a peripheral device clock time;
read the peripheral device counter value;
compute a clock correction as a function of a difference between the host device clock time and the peripheral clock time, based on the host device counter value, the host device clock translation parameters, the peripheral device counter value, and the peripheral device clock translation parameters; and
correct the host device clock translation parameters or the peripheral device clock translation parameters based on the clock correction.

2. The device according to claim 1, wherein the peripheral device clock translation parameters are stored in the host memory, and the processing circuitry is configured to read the peripheral device clock translation parameters from the host memory.

3. The device according to claim 1, wherein the processing circuitry is to correct the peripheral device clock translation parameters thereby causing the peripheral device clock time to follow the host device clock time.

4. The device according to claim 3, wherein the peripheral device clock translation parameters are stored in the host memory, and the processing circuitry is to correct the peripheral device clock translation parameters in the host memory.

5. The device according to claim 3, wherein the peripheral device clock translation parameters are stored in the peripheral device, and the processing circuitry is to correct the peripheral device clock translation parameters stored in the peripheral device.

6. The device according to claim 1, wherein the processing circuitry is to correct the host device clock translation parameters thereby causing the host device clock time to follow the peripheral device clock time.

7. The device according to claim 1, wherein the processing circuitry is to receive the host device counter value from a data communication bus root port of the host device.

8. The device according to claim 1, wherein the processing circuitry is to correct multiple sets of peripheral device translation parameters providing translations between the peripheral device counter value and respective peripheral device clock times with respect to respective host device clock times of respective multiple host machines.

9. The device according to claim 8, wherein the processing circuitry is to correct the multiple sets of the peripheral device translation parameters stored in host memories of the respective multiple host machines.

10. The device according to claim 1, wherein the processing circuitry is to correct multiple sets of host device translation parameters providing translations between host device counter values and respective host device clock times of respective multiple host machines with respect to the peripheral device clock time causing each of the host device clock times to follow the peripheral device clock time.

11. The device according to claim 10, wherein the processing circuitry is to correct the multiple sets of the host device translation parameters stored in host memories of the respective multiple host machines.

12. A system, comprising:
the peripheral device according to claim 1; and
a host device to execute software to offload to the peripheral device:
computation of the clock correction; and
correction of the host device clock translation parameters or the peripheral device clock translation parameters based on the clock correction.

13. A host device, comprising:
an oscillator;
a counter to be driven by the oscillator and provide a host device counter value;
a host memory to store host device clock translation parameters providing a translation between the host device counter value and a host device clock time;
a data communication bus root port to:
receive a peripheral device counter value from a peripheral device via a data communication bus;
read peripheral device clock translation parameters from the host memory, the peripheral device clock translation parameters providing a translation between the peripheral device counter value and a peripheral device clock time;
read the host device clock translation parameters from the host memory;
compute a clock correction as a function of a difference between the host device clock time and the peripheral clock time, based on the host device counter value, the host device clock translation parameters, the peripheral device counter value, and the peripheral device clock translation parameters; and
correct the host device clock translation parameters or the peripheral device clock translation parameters based on the clock correction.

14. The device according to claim 13, wherein the data communication bus root port is to correct the peripheral device clock translation parameters thereby causing the peripheral device clock time to follow the host device clock time.

15. The device according to claim 13, wherein the data communication bus root port is to correct the host device clock translation parameters thereby causing the host device clock time to follow the peripheral device clock time.

16. A method, comprising:
driving a counter by an oscillator;
providing, by the counter, a peripheral device counter value;
receiving a host device counter value from a host device;
reading host device clock translation parameters from a host memory of the host device, the host device clock translation parameters providing a translation between the host device counter value and a host device clock time;
reading peripheral device clock translation parameters, the peripheral device clock translation parameters providing a translation between the peripheral device counter value and a peripheral device clock time;
reading the peripheral device counter value;
computing a clock correction as a function of a difference between the host device clock time and the peripheral clock time, based on the host device counter value, the host device clock translation parameters, the peripheral device counter value, and the peripheral device clock translation parameters; and
correcting the host device clock translation parameters or the peripheral device clock translation parameters based on the clock correction.

17. The method according to claim 16, wherein the correcting includes correcting the peripheral device clock translation parameters thereby causing the peripheral device clock time to follow the host device clock time.

18. The method according to claim 16, wherein the correcting includes correcting the host device clock translation parameters thereby causing the host device clock time to follow the peripheral device clock time.

19. The method according to claim 16, wherein the correcting includes correcting multiple sets of peripheral device translation parameters providing translations between the peripheral device counter value and respective peripheral device clock times with respect to respective host device clock times of respective multiple host machines.

20. The method according to claim 16, wherein the correcting includes correcting multiple sets of host device translation parameters providing translations between host device counter values and respective host device clock times of respective multiple host machines with respect to the peripheral device clock time causing each of the host device clock times to follow the peripheral device clock time.

21. A method, comprising:
driving a counter by an oscillator;
providing, by the counter, a host device counter value;
storing host device clock translation parameters providing a translation between the host device counter value and a host device clock time;
receiving, by a data communication bus root port, a peripheral device counter value from a peripheral device via a data communication bus;
reading, by the data communication bus root port, peripheral device clock translation parameters from the host memory, the peripheral device clock translation parameters providing a translation between the peripheral device counter value and a peripheral device clock time;
reading, by the data communication bus root port, the host device clock translation parameters from the host memory;
computing, by the data communication bus root port, a clock correction as a function of a difference between the host device clock time and the peripheral clock time, based on the host device counter value, the host device clock translation parameters, the peripheral device counter value, and the peripheral device clock translation parameters; and
correcting, by the data communication bus root port, the host device clock translation parameters or the peripheral device clock translation parameters based on the clock correction.
